(19) United States
(12) Patent Application Publication
(10) Pub. No.: US 2024/0378674 A1
(43) Pub. Date: Nov. 14, 2024

(54) SYSTEM AND METHOD FOR MONITORING THE CORPORATE ACTIVITY AND STOCK FILINGS OF PRIVATE COMPANIES

(71) Applicant: BrightQuery, Inc., Irvine, CA (US)

(72) Inventors: Jose M Plehn-Dujowich, Huntington Beach, CA (US); Scott Openlander, Chicago, IL (US); Mainak Sarkar, Irvine, CA (US)

(21) Appl. No.: 18/662,671

(22) Filed: May 13, 2024

Related U.S. Application Data
(60) Provisional application No. 63/501,866, filed on May 12, 2023.

(51) Int. Cl. G06Q 40/06

(52) U.S. Cl. CPC G06Q 40/06

(57) ABSTRACT

A method for monitoring and reporting the corporate activity and stock filings of private companies comprising the steps of: obtaining relevant raw data from informational documents obtained from publicly available sources; cleaning, parsing and classifying the raw data contained within the informational documents into intermediate data; and using the intermediate data to create final data, wherein the final data is fed into reports prepared for users. The disclosed method is configured to make use of these publicly available informational documents in order to generate and provide reports to potential investors, these reports having relevant company information, allowing investors to make informed investment decisions regarding the company. The reports may include company identity, a status summary, key data on stock filings, history of the authorized shares issued, a corporate tree which sets out company relationships to branches and officers, and information on corporate officers and directors of branches.

### CROSS-REFERENCE TO RELATED APPLICATIONS

This application claims priority to U.S. Provisional application Ser. No. 63/501,866, filed May 12, 2023, which is hereby incorporated by reference, to the extent that it is not conflicting with the present application.

### BACKGROUND OF INVENTION

### 1. Field of the Invention

The invention relates generally to a system and method for monitoring and reporting behaviors of companies and specifically to a system and method for monitoring and reporting the corporate activity and stock filings of private companies.

### 2. Description of the Related Art

When making investments, it is often useful to have access to a large amount of information on a company in order to obtain a full picture of how the company is performing. The number of private companies, and the limited information available on their operations, makes it difficult to implement sound investment decisions. Additionally, data available on these private companies may not be in a desirable format, making it difficult to extract the information necessary to monitor their activity and access their performance. There is thus a need to collect information, from public sources, on a range of financial and other issues of private companies and present this data in such a way as to provide users with a clear picture of a firm.

Therefore, there is a need to solve the problems described above by proving a system and method for monitoring and reporting the corporate activity and stock filings of private companies

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a method for monitoring and reporting the corporate activity and stock filings of private companies is provided, the method for monitoring and reporting the corporate activity and stock filings of private companies comprising the steps of obtaining relevant raw data from informational documents from publicly available sources, cleaning parsing and classifying the raw data contained within the documents into intermediate data, and preparing the intermediate data into final data fed into reports prepared for users. Thus an advantage is that potential naming inconsistencies within the raw data may be identified and resolved in order to ensure that information collected for each private company is properly attributed to said private company. Another advantage is that the raw data for private companies may be efficiently collected from a variety of sources and processed in order to provide a representation of the performance and status of the private companies. This may allow potential investors to make informed decisions regarding if they should invest in a private company. Another advantage is that the final data generated by the above method may be presented to a user in easy to understand format, such as graphs and tables. This may allow a user to quickly assess the available data on a private company to determine if they should invest with said private company.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the raw data processing flowchart for the process of parsing, cleaning and normalizing raw business registration data, according to an aspect.

FIG. 2 illustrates the flowchart for the process of creating a matching algorithm foundation used to match any company to an existing list of processed and validated companies, according to an aspect.

FIG. 3 illustrates the flowchart for the procedure of refining Delaware stock filing XML documents into relevant data and statistics, according to an aspect.

FIG. 4 illustrates a graph configured to identify the linkages of the companies via the officers and directors, according to an aspect.

FIG. 5 illustrates the flowchart for the procedure of processing Delaware stock filing XML documents into relevant data and statistics, according to an aspect.

FIG. 6 illustrates the flowchart for the parsing and cleansing of raw corporate filings, according to an aspect.

FIG. 7 illustrates the flowchart for the generation of the taxonomy, wherein the taxonomy is created to standardize the types of filings that are possible, according to an aspect.

FIG. 8 illustrates the flowchart for the procedure of processing Delaware stock filing XML documents into relevant data and statistics, according to an aspect.

FIG. 9 illustrates the flowchart for the procedure of processing Delaware stock filing XML documents into relevant data and statistics, according to an aspect.

FIG. 10A illustrates the data flow diagram for the bulk data update, according to an aspect.

FIG. 10B illustrates a corporate data table of the information relevant to the corporate family tree and its associated description, according to an aspect.

FIG. 11 illustrates a table of company identifiers and a stock filing tax summary, according to an aspect.

FIG. 12 illustrates a graph of company par value, according to an aspect.

FIG. 13 illustrates a graph of daily total assets for a company, according to an aspect.

FIG. 14 illustrates a filing events selection interface, according to an aspect.

FIG. 15 illustrates a stock class series daily graph, according to an aspect.

FIG. 16 illustrates a stock class series table, according to an aspect.

FIG. 17 illustrates a most recent stock class series filing table, according to an aspect.

FIG. 18 illustrates a stock class series daily graph configured to permit early warning and alerts of private company's activities, according to an aspect.

FIG. 19 illustrates a corporate family tree chart, according to an aspect.

FIG. 20 illustrates a Delaware parent company identity table, according to an aspect.

FIG. 21 illustrates a corporate tree summary graph, according to an embodiment.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

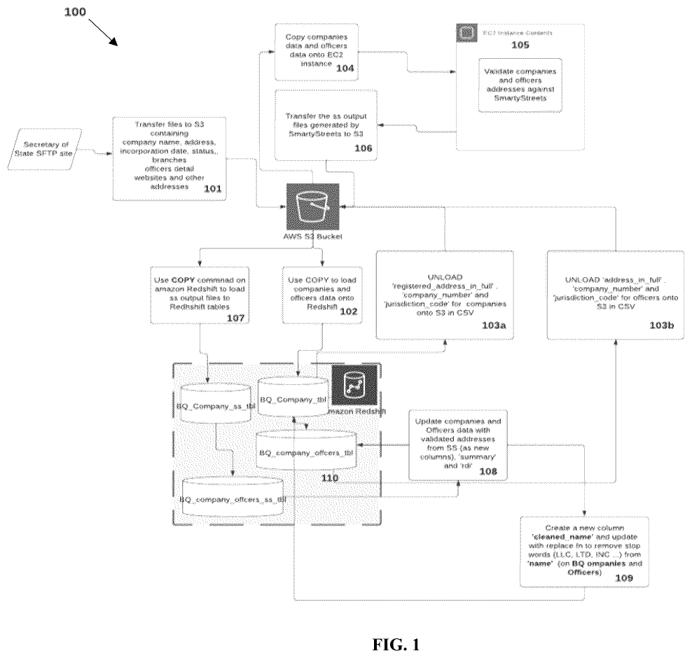

FIG. 1 illustrates the raw data processing flowchart 100 for the process of parsing, cleaning and normalizing raw business registration data, according to an aspect. As will be articulated hereinbelow, a method and system has been developed by which the corporate activity and stock filings of private companies having a parent legal entity with a jurisdiction in the United States are monitored in a systematic manner. Raw inputs from government agencies that feed into the system are combined to create intermediate data, which is then used to create the final data that feeds into reports prepared for users. Given the wide variety and variable quality of the data, this tool cleanses, standardizes and matches the data using existing or new algorithms. The output data is modeled on a business intelligence platform to visualize the information and create reports to make informed decisions about investments and loans to private companies.

The hereinbelow articulated system and process, referred to herein as BrightQuery (BQ), analyzes private companies in the same way as is done for public companies. It functions as a ‘one stop shop’ for a range of metadata on private firms, gleaned from stock filings and tax records. The information is cleansed, parsed and classified using a unique taxonomy for companies registered in the State of Delaware.

The description disclosed hereinbelow presents a system and method for monitoring the corporate activity and stock filings of private companies having a parent legal entity with a jurisdiction in the United States. It sets out the various parts of this system and the specific actions involved. What follows is a brief summary of these parts.

At the most basic level, raw data from government agencies is combined to create intermediate data, which is used to produce the ‘polished’ data that is included in the final report for users. The raw data includes: business registrations; names of directors and officers; and tax payments to the State of Delaware; as well as corporate, stock, securities, tax and employment filings with a range of authorities, including the State of Delaware, the Securities and Exchange Commission (SEC), the Internal Revenue Service and the Department of Labor.

The next stage is the ‘cleansing’ and preparation of this raw data to create intermediate data. The steps in this area may include: creation of a corporate family tree; the setting up of linkages with directors and officers; creation of metadata on taxes and corporate status, filing history, stock filings with Delaware State, and securities, tax and employment filings with the SEC, IRS and Department of Labor, respectively.

The output data is modeled on a business intelligence platform to ‘visualize’ the information and create reports. The data includes: company identity; a status summary; key data on stock filings; history of the authorized shares issued; a corporate tree which sets out company relationships to branches and officers; and information on corporate officers and directors of branches. A number of potential future developments for the herein disclosed system and method will be disclosed hereinbelow.

This description hereinbelow will describe the various raw inputs from government agencies that feed into the system. These raw inputs are then combined to create intermediate data, which is then used to create the final data that feeds into the reports consumed by users.

A first type of raw input may be business registrations. A company must file with a Secretary of State in a particular jurisdiction to register as a business. The business may be headquartered in that State or have another State as its home jurisdiction. Moreover, a company may have a holding legal entity in a specific State purely to serve as the corporate parent. The State of Delaware is a common jurisdiction that is used for the legal entity that serves as the corporate parent, in part because it has a favorable legal framework for enterprises. It is necessary to obtain such information to be aware of the legal entities that exist and their structure. These then serve as the foundation to identify and track organizations.

A second type of raw input may be director and officer information. Information on directors and officers is obtained from the State of Delaware, and all other States in the U.S. Directors and officers represent the individuals or organizations that control the legal entity. Information on directors and officers from Delaware is obtained in XML format, while those from other States are obtained in CSV format. It is necessary to obtain such information to understand the leadership structure of the organization and the various relationships that may exist across legal entities and organizations, to help form the corporate family tree.

A third type of raw input may be tax payments to the State of Delaware. Legal entities registered with the State of Delaware must pay taxes to the State based on a number of factors, including the type of legal entity and number of shares that have been authorized. It is necessary to obtain such information to understand the financial commitments and standing of the underlying legal entity.

A fourth type of raw input may be corporate filings with the state of Delaware. Legal entities registered with the State of Delaware submit filings pertaining to corporate actions, including formation, mergers, change of agent, and dissolutions. Formation documents are provided to the State when the company is established. It is necessary to obtain such information to track when a company is set up, identify if it has merged with another entity, or has been dissolved. This helps one to identify changes in corporate identity.

A fifth type of raw input may be stock filings with the State of Delaware. Legal entities registered with the State of Delaware submit filings pertaining to stock authorizations, stock issuances, and total assets. These filings include Amendments and Restatements, among others. It is necessary to obtain such information to track when a company has authorized additional shares of common and/or preferred stock, how many have been issued, and what changes, if any, transpired with regard to its reported total assets.

A sixth type of raw input may be security filings with the Securities and Exchange Commission (SEC). Legal entities register with the SEC and submit filings, including Form D, Form C, Form S-1, and various other filings. These filings are required by companies that raise capital from private investors, public capital markets, crowdsourcing platforms, and various other investment vehicles. It is necessary to obtain such information to identify which organizations are private versus publicly traded, and to identify private companies that have raised capital from the private capital markets.

A seventh type of raw input may be tax filings with the Internal Revenue Service (IRS). Legal entities that wish to serve as non-profits must receive approval from the IRS to be treated as such, as this allows them to be tax-exempt. Once non-profit status has been granted by the IRS, Form 990 is submitted in lieu of a traditional tax return. There is a family of filings associated with Form 990, each of which is required depending on the type of entity submitting the filing. It is necessary to obtain such information to identify which organizations are non-profits. A non-profit organization does not typically raise capital the same way as do for-profit organizations. Rather, they rely on donations and programs run for charitable purposes.

An eighth type of raw input may be employment filings with the Department of Labor and Internal Revenue Service. Companies that offer employee benefits in the U.S. must file Form 5500 with the IRS and Dept. of Labor. There are two types of benefit plans: retirement benefits, such as 401(k) and profit sharing; and welfare benefits, such as health and dental plans. It is necessary to obtain such information to identify which organizations offer employee benefits and to understand the structure of their compensation and benefits scheme. While these eight raw inputs may be utilized in an embodiment of the disclosed BrightQuery (BQ) system, it should be understood that more or fewer raw input sources may be utilized to collect the necessary information, depending on the specific application.

With the potential source of raw inputs identified, the below description may describe an embodiment of how the raw input data is cleansed and prepared to generate intermediate data, as seen in FIG. 1, for the creation of a corporate family tree. The raw business registration data from the State of Delaware and other States arrives in JSON, Excel and CSV formats. This must be parsed, cleansed and normalized. This process is depicted in FIG. 1.

The raw business registration data is received and stored in a cloud storage location (S3 bucket) in step 101 using proprietary code written in Python. Once the data is stored, it is copied to the database server in step 102. The storage can be of any type: a conventional storage medium, including, but not limited to, a floppy disk, a compact disk, a magnetic tape, a read only memory, an optical storage medium, universal serial bus (USB) flash drive, a digital versatile disc, or a zip drive. Once loaded, only address and company files are extracted for companies and information on officers is extracted from cloud storage in Step 104. Steps 103a and 103b are database commands configured to copy company address, jurisdiction, and company name data for companies and officers, respectively, from the database to Amazon cloud storage.

Once uploaded for street address validation by the United States Postal Service (USPS) in step 105, the output of the street validation in step 106 is the validated comma separated data files (labeled ‘SS’). These files are loaded in cloud storage, which are then copied to the database server in step 107. In step 108, company and officer data is enriched by the validated street address SS files. To further help with matching, company names are standardized and cleansed in step 109. Cleansed company Officer details may be stored in the cloud storage database, such as Amazon Redshift in step 110. Company names are often full of data quality issues and abbreviated in many ways, which could pose significant challenges in matching. So, several instructions have been created to cleanse the names and standardize them by removing certain keywords, stop words, filling in abbreviations, etc. The instructions could also be embodied in a random access memory, or other type of electronic storage, located on a remote storage system and coupled to memory. As shown in FIG. 1, Business registrations are combined to form a corporate family tree for every organization. Companies for which the parent entity is registered in Delaware are initially considered.

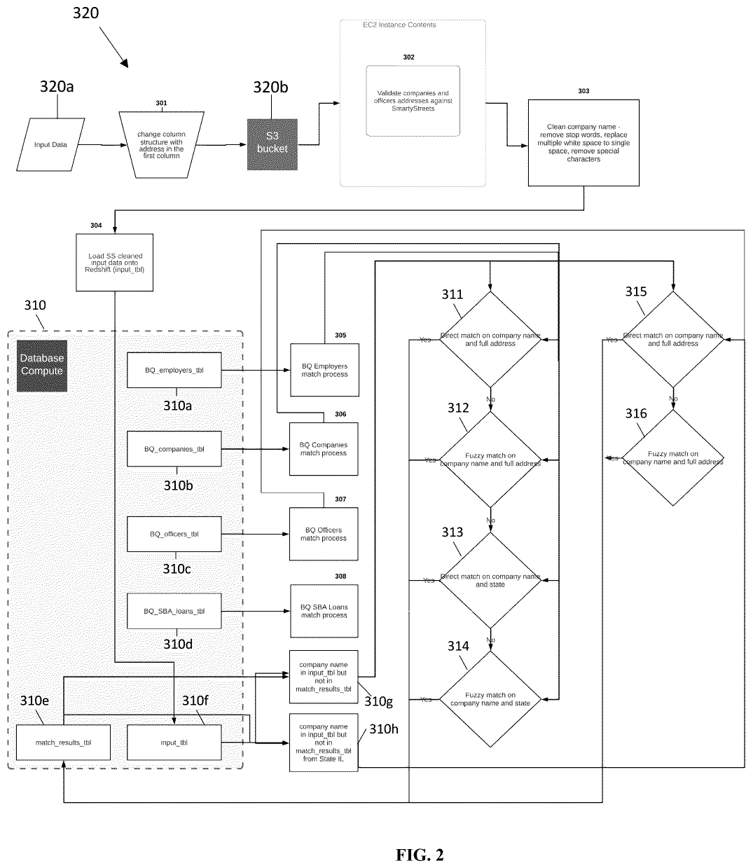

FIG. 2 illustrates the flowchart for the process of creating a matching algorithm foundation 320 used to match any company to an existing list of processed and validated companies, according to an aspect. FIG. 2 shows the steps that have been developed to create an extensive and elaborate matching algorithm foundation used to match any company to the existing list of processed and validated companies list. A computer readable non-transitory storage medium stores instructions of a computer program, which when executed by a computer system results in the performance of the steps of the method.

Several existing matching algorithms have been investigated, reviewed and analyzed to understand the existing landscape of matching algorithms in terms of performance, computing cost, case of maintenance and use. However, it was found that there is no single matching algorithm that can solve the matching problem at hand. Entities could be large corporations which can be public or private, small and medium sized businesses or sole proprietors. Often, names could have data quality issues or have abbreviations that could pose matching challenges against the existing list of companies. Or there might only be an address, which could potentially be incorrect. Consequently, the above steps with the algorithm go through cleansing, standardization and matching within sub-lists of existing companies using various sets of existing or new algorithms to complete a successful matching. At the end of the matching, a detailed list of matching types, along with the number of matches, is generated.

More specifically, as shown in FIG. 2, the disclosed process of creating a matching algorithm foundation 320 may begin, starting with obtaining the input data 320a that will be used for name matching and changing the column structure of the input data, putting the address in the first column 301. After changing the column structure of the input data, the modified input data may be stored in an S3 bucket 320b before validating the companies and officers address against those on an address verification system 302, such as SmartyStreets. From there, the process may continue by cleaning 303 the company name by removing stop words, replacing multiple spaces within the name with singular spaces and removing special characters. At this point, the resultant cleaned input data may be loaded 304 onto a suitable cloud storage database 310, such as Amazon Redshift, and stored in an input database 310f.

Within the cloud storage database, different storage partitions may exist for the storage of relevant information, including employer database 310a, company database 310b, officer database 310c and SBA loan database 310d. Each the databases may be used may be queried by a corresponding match process to try to suitably match the corresponding cleaned input data against available known data, such as an employer match process 305, a company match process 306, an officer match process 307 and an SBA loans match process 308, accordingly. Certain match processes 305-307 may first attempt to get a direct match on company name and full address 311. If a direct match for the company name and full address is unsuccessful (e.g., no match), a fuzzy match for the company name and full address will be attempted 312. If the fuzzy match for the company name and full address is unsuccessful, a direct match of the company name and state will be attempted 313, if the direct match of the company name and state is unsuccessful, a fuzzy match of the company name and state will be attempted 314. If at any point a match 311-314 is successful, match results will be stored within match results database 310 of the cloud storage database 310.

The resultant information match results database 310e may utilized with the information on the input database 310f to assess if the company name is in the input database 310f, but not in the match results database 310e in step 310g, or if the company name is in the input database 310f but not in the match results database 310e from State IL, in step 310h. If either is true, the matching process may be repeated by attempting a direct match on company name and full address 315, and if unsuccessful, a fuzzy match on company name and full address 316. The result of this matching process may again be stored on the match results database 310c.

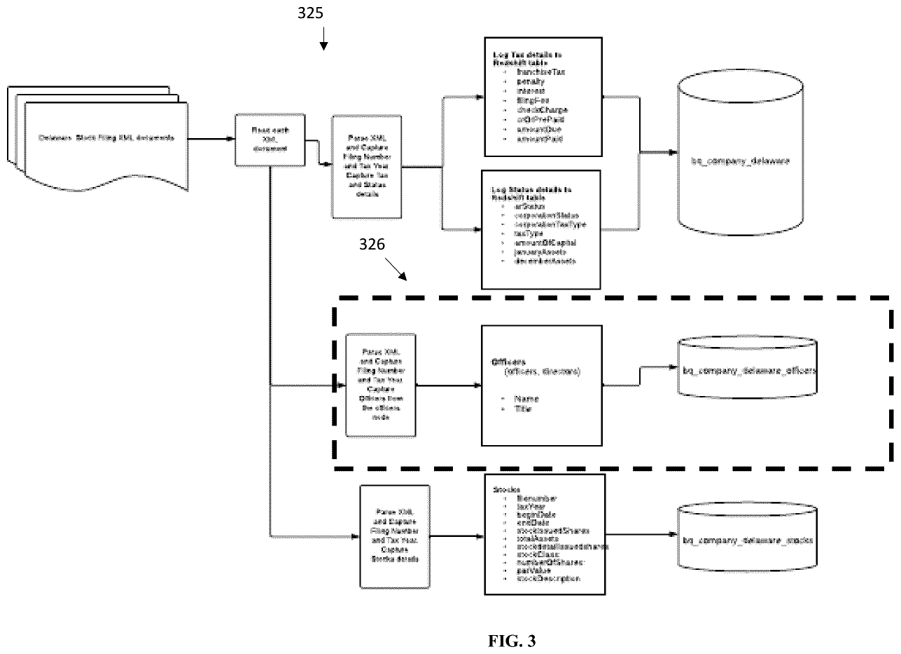

FIG. 3 illustrates the flowchart for the procedure of processing Delaware stock filing XML documents into relevant data and statistics 325, according to an aspect. FIG. 4 illustrates a corporate linkage graph 430 configured to identify the linkages of the companies via the officers and directors, according to an aspect. An important aspect of the disclosed system is the creation of linkages between directors and officers. As can be seen in FIG. 3, the raw directors and officers data from the State of Delaware arrives in XML format. This must be parsed, cleaned and normalized. The below disclosure may be used to describe the officer based information extraction process 326.

The XML files are stored in simple cloud storage (S3 bucket) using a set of simple software code. The storage could be any other form of computer storage, including a local computer storage or a hard disk. This process, shown in FIG. 3, relates to the arts of data conversion and processing for loading databases with certain sets of data attributes and, more specifically, for loading certain text contained in document files which are in a markup language such as Extensible Markup Language (XML). These XML documents could be extensive, complex and fraught with data quality issues, where certain tags might be missing, or the format of the XML structure can vary from one time period to another. So, a software code has been developed in the object oriented programming language Python and Structured Query Language (SQL) to: parse the XML document; identify any data quality issues; the specific nodes to be captured; generate the database commands, such as SQL statements, to execute against the database to load the XML file into the database; and establishing communication with a database server and issuing the database commands to accomplish the data loading. These code instructions parse the XML document to: capture the Delaware company file number; tax year; tax details; stock details, including issues shared, number of shares, total assets, beginning and end dates, and officers data, including name, position and address. The data is loaded into appropriate tables.

Data on directors 433 and officers 432 across legal entities are then matched with one another to identify corporate linkages and affiliations (shown by the arrows), as seen in FIG. 4. Extensive cleansing and matching of the individual 431 names, addresses and positions are carried out to identify the officers and directors of companies. Each officer 432 and director 433 is then mapped to each company 434 they are associated with. Thus, a complex corporate linkage graph 430 is created to identify the linkages of the companies via officers 432 and directors 433.

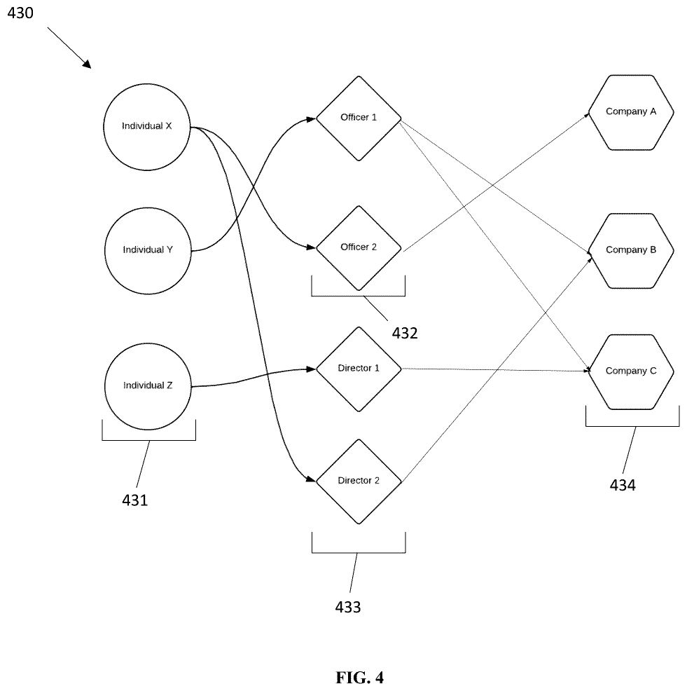

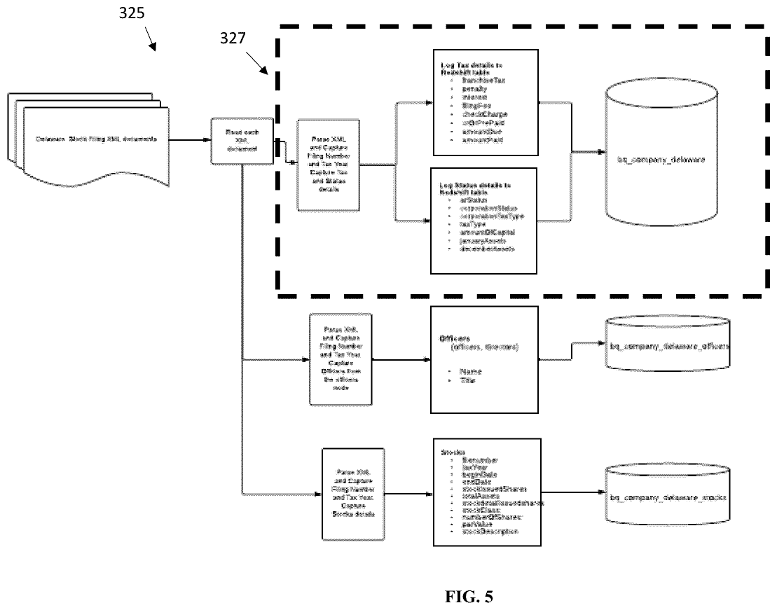

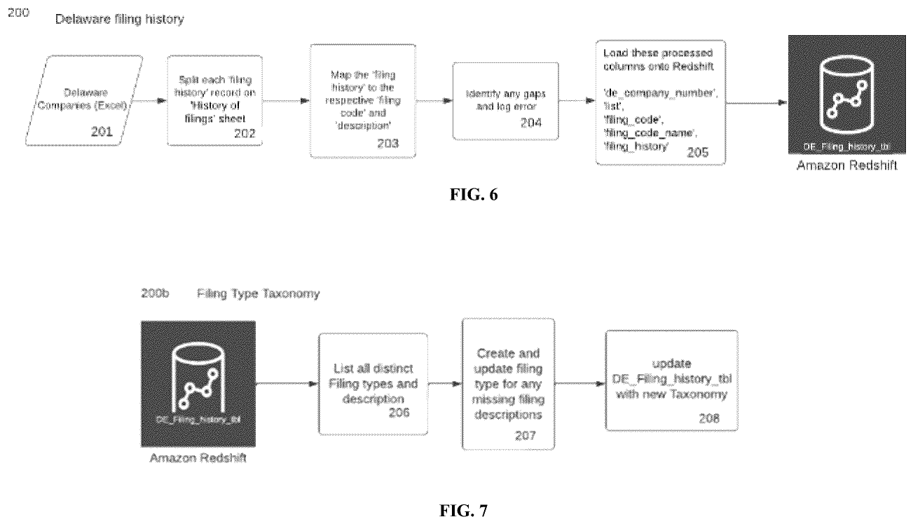

FIG. 5 illustrates the flowchart for the procedure of processing Delaware stock filing XML documents into relevant data and statistics, according to an aspect. FIG. 6 illustrates the flowchart for the parsing and cleansing of raw corporate filings, according to an aspect. FIG. 7 illustrates the flowchart for the generation of the taxonomy, wherein the taxonomy is created to standardize the types of filings that are possible, according to an aspect. Another important aspect of the disclosed system is the creation of metadata on taxes and corporate status in the State of Delaware. The below disclosure may be used to describe the tax and status based information extraction process 327.

Similarly to the disclosed raw directors and officers data of FIG. 3, the raw tax and corporate status data from the State of Delaware arrives in XML format. This must be parsed and cleansed. FIG. 5 explains the process of receiving, storing, and parsing XML documents to capture the tax and corporate status of the companies. A taxonomy must be created that standardizes the tax status and the corporate status. Corporate status options include Good Standing, etc. Tax status options include accounts receivable (A/R), etc.

Similarly to the above described creation of metadata on taxes and corporates status, it may also be necessary to create metadata on filing history with the State of Delaware. The raw corporate filings from the State of Delaware arrive in manually entered format as seen in step 201 of FIG. 6. Again, these filings must be parsed and cleansed. The process of cleansing and parsing these filings may be described in Steps 201-205 in FIG. 6, and may be described hereinbelow.

As seen in Step 201 of FIG. 6, Delaware raw corporate filings data is received from the State of Delaware and loaded into the S3 bucket. In Step 202, Given the nature of the origin of the data, there are data quality issues. Code is written to split each history record into separate columns. In the following Step 203, the history record is evaluated against the BQ filing type taxonomy and updated with the filing types. Next, in Step 204, the code logs the data quality issues into the cloud database Redshift for future review. All data quality issues are identified and logged into Redshift. Redshift could be replaced with any similar database storage and computing platform. Finally, in Step 205, filing history data is loaded into a Redshift table. Before loading, the data is validated against the date dimension table, which permits the capture of filing events on a timeline. This will allow for easy visualization of the corporate filing events.

Following the loading of the filing history data into a Redshift table, as seen in Step 205 of FIG. 6, a taxonomy must be created that standardizes the types of filings that are possible. This includes Formation Document, Merger, etc. The steps used to generate the taxonomy may be seen in FIG. 7, as described by Steps 206-208 below. As seen Step 206 of FIG. 7, SQL statements are created to list all distinct filing types (code #s) and descriptions. Again, these are not consistent, and several data quality issues can be identified due to the manual nature of the filing process with the State of Delaware. Next, in the following Step 207, a thorough review of these filing types has been done and the filing types are standardized and updated. Finally, as seen in Step 208, the list is uploaded to the database using SQL statements and then the Delaware filing history table is updated with the new taxonomy.

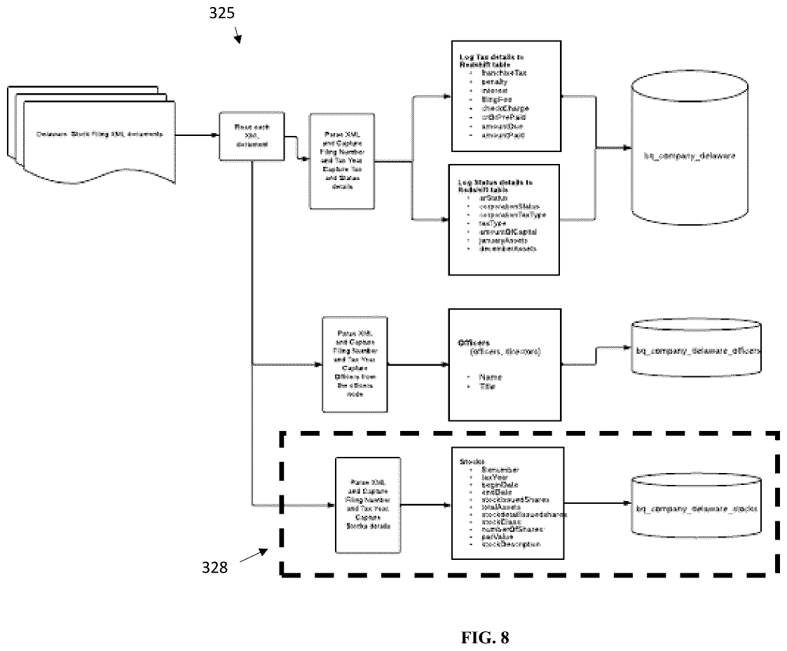

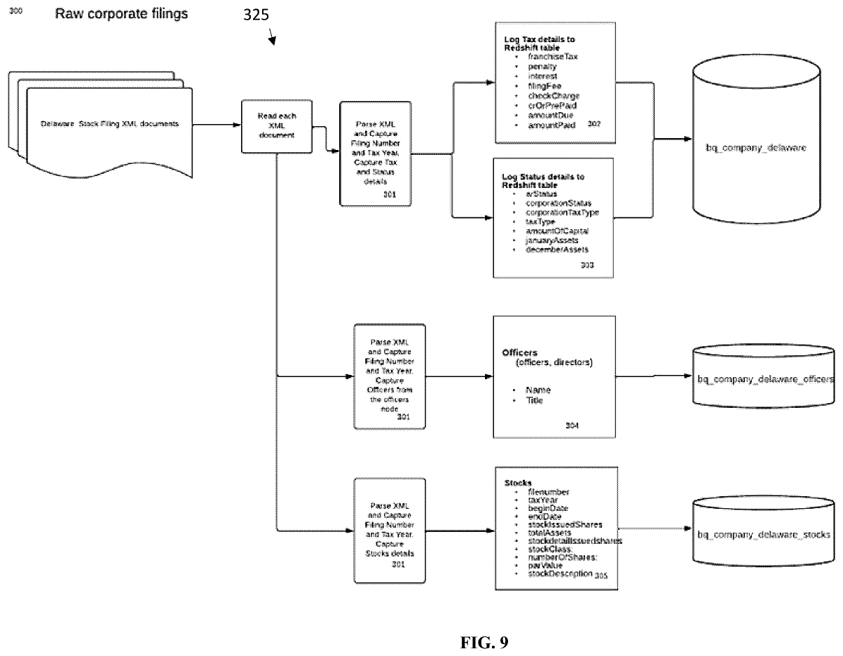

FIG. 8 illustrates the flowchart for the procedure of processing Delaware stock filing XML documents into relevant data and statistics, according to an aspect. FIG. 9 illustrates the flowchart for the overall procedure of processing Delaware stock filing XML documents into relevant data and statistics, according to an aspect. Another important aspect of the disclosed system is the creation of metadata on stock filings with the State of Delaware. The below disclosure may be used to describe the stock based information extraction process 328.

Similarly to the disclosed raw directors and officers data of FIG. 3, the raw corporate filings from the State of Delaware arrive in manually entered format, which must be parsed and cleansed. A taxonomy must be created that standardizes the types of stock authorizations that are possible. This includes Stock Class and Stock Type. Stock Class is classified into two groups: Common and Preferred. Stock Type is classified into various groups. Each group varies depending on the Stock Class. For Common, we have Voting, Non-Voting. For Preferred, we have FF, Series A, etc.

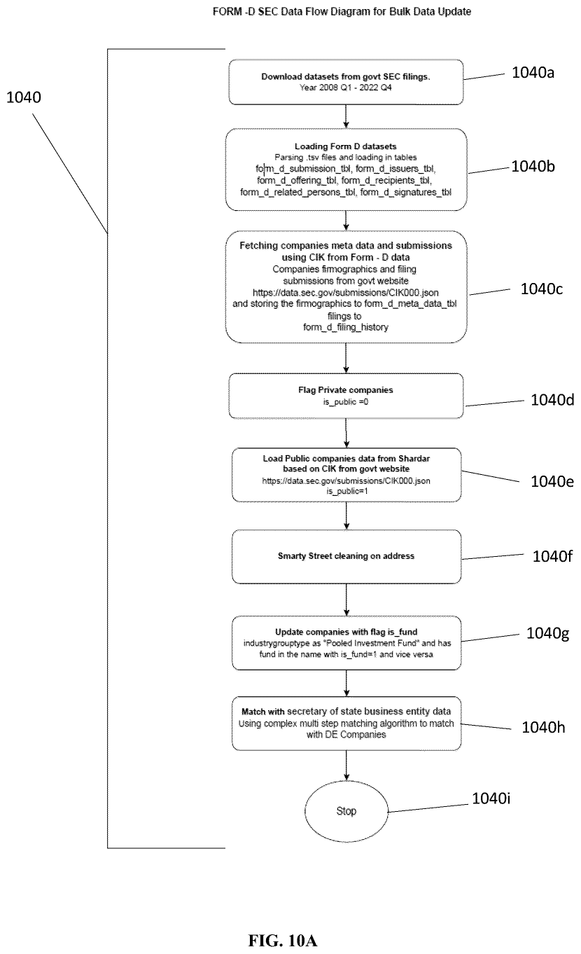

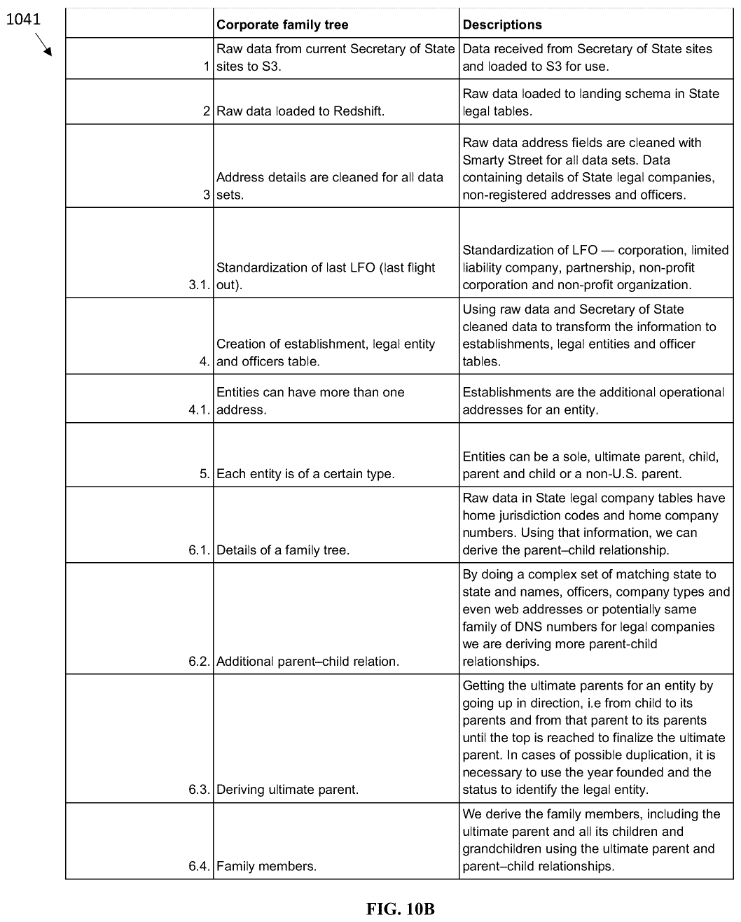

FIG. 10A illustrates the data flow diagram for the bulk data update 1040, according to an aspect. FIG. 10B illustrates a corporate data table 1041 of the information relevant to the corporate family tree and its associated description, according to an aspect. Another important aspect of the disclosed system is the creation of metadata on securities filings with the SEC. To date, there has been no methodology that identifies Delaware registered private companies, whereas public companies can be studied using a number of techniques and data obtained from SEC forms D, C and 10-K. The following approach uses publicly available data and a complex matching algorithm to identify those Delaware registered companies which are public and private, as seen in FIG. 10A and FIG. 10B.

More specifically, as depicted in FIG. 10A, the data flow diagram for the bulk data update 1040 may consist of multiple steps. The bulk data update process 1040 may begin with the downloading of corresponding datasets from government SEC filings 1040a, followed by loading the associated Form D datasets and parsing the available.tsv files and loading in the corresponding tables 1040b. The following step may proceed with the fetching of companies' meta data submissions using CIK from Form D data 1040c. This meta data may include companies' firmographics and filing submissions from a corresponding government website, wherein said meta data may be stored to a metadata database.

Following the fetching of the meta data, companies may be flagged 1040d, accordingly. With the private companies flagged, the bulk data update process 1040 may continue with the loading of public company data from Shardar based on CIK from a corresponding government website 1040e. From there, a corresponding address may be cleansed 1040f using SmartyStreets, or another suitable address verification system. After performing the mentioned cleansing of the address, the process may update companies with the flag “is_fund” to check if it is part of the fund 1040g. Finally the last step of the bulk data update process 1040 may be to match the provided data with secretary of state business entity data 1040h, through the usage of a suitable match algorithm to match with DE companies. With this final step of the process performed, the bulk data update process may stop 1040i.

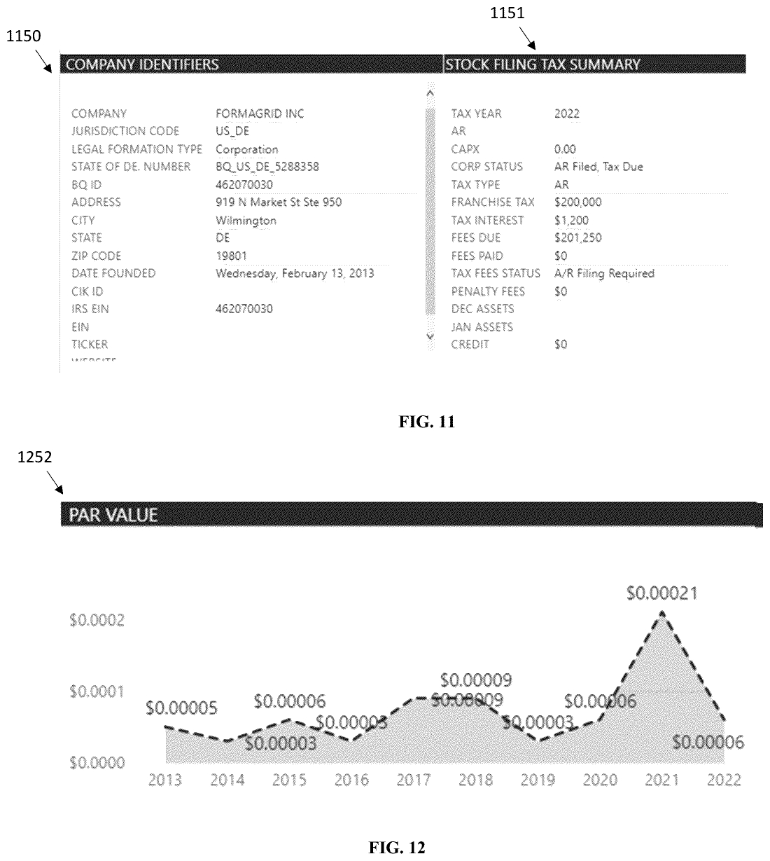

FIG. 11 illustrates a table of company identifiers 1150 and a stock filing tax summary 1151, according to an aspect. With the hereinabove described intermediate data collected, as described hereinabove, said intermediate data may be utilized to generate output data for suitable reports and derived analytics. The output data is modeled on a business intelligence (BI) platform to visualize the information and create reports. These reports are read by analysts to make informed decisions about investments and loans to private companies. Company identifiers 1150, as seen in FIG. 11 are sourced from various State and government filing sources. Legal name, address, website, legal structure, employer identification number (EIN) and other information is required to ensure accurate ‘matching,’ compliance and underwriting of private companies.

As seen in the status summary of FIG. 11, the status reveals if the company or legal entity is in good standing with the state of incorporation. In an embodiment, this instant and timely view can only be done for all US based private companies by the process of including, cleansing and matching various government data sources for verification of good standing.

FIG. 12 illustrates a graph of company par value 1252, according to an aspect. Key stock filing data may be shown in the company par value graph of FIG. 12. Normally, filing data that is unavailable can include company par value, shares authorized and issued as well as total assets at the time of each filing. Time series data permits trend analysis of private company stock filings.

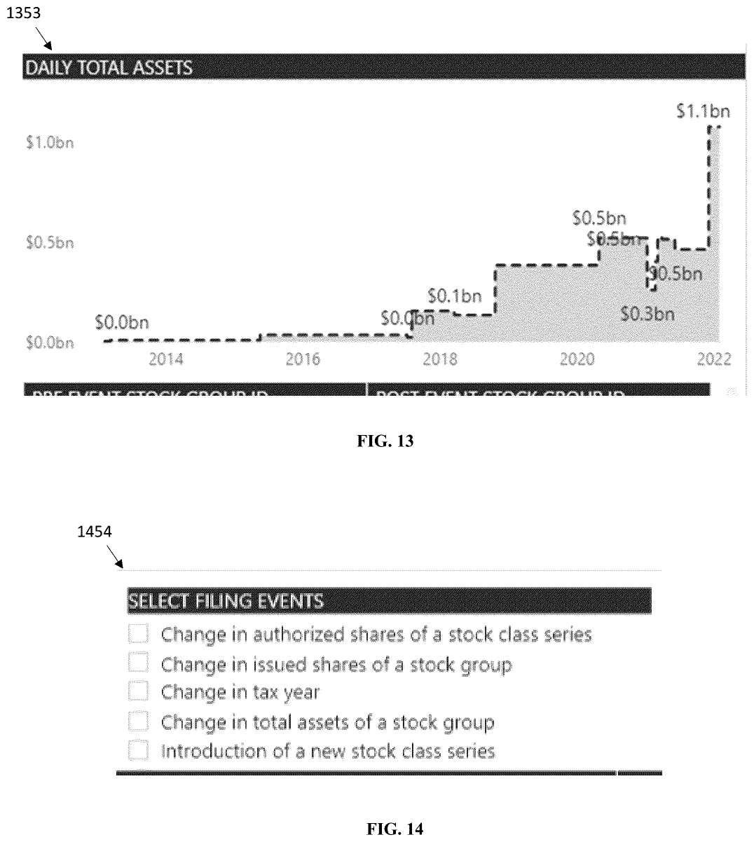

FIG. 13 illustrates a graph of daily total assets for a company 1353, according to an aspect. Trends of total assets permit estimation of cash invested for each new stock filing, or the likelihood of companies issuing new stock if capital must be raised. The ability to provide total assets, as seen in FIG. 13, permits insights into private companies that are not normally available. Data on total assets permit the ability to impute a company's size, cash burn and predictive risk models.

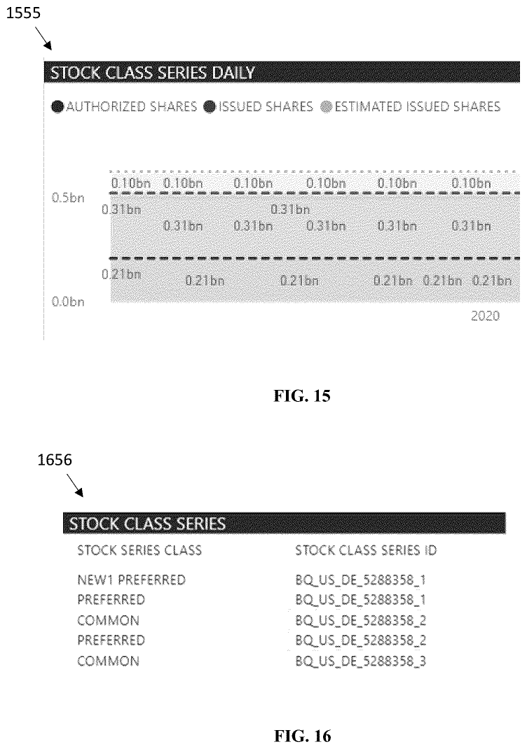

FIG. 14 illustrates a filing events selection interface 1454, according to an aspect. FIG. 15 illustrates a stock class series daily graph 1555, according to an aspect. FIG. 16 illustrates a stock class series table 1656, according to an aspect. FIG. 17 illustrates a most recent stock class series filing table 1757, according to an aspect. Tracking shares authorized and issued by stock class also provides insights into normally unavailable data. Changes in shares, total assets, series and classes permit current insights and imputations of a company's future activities.

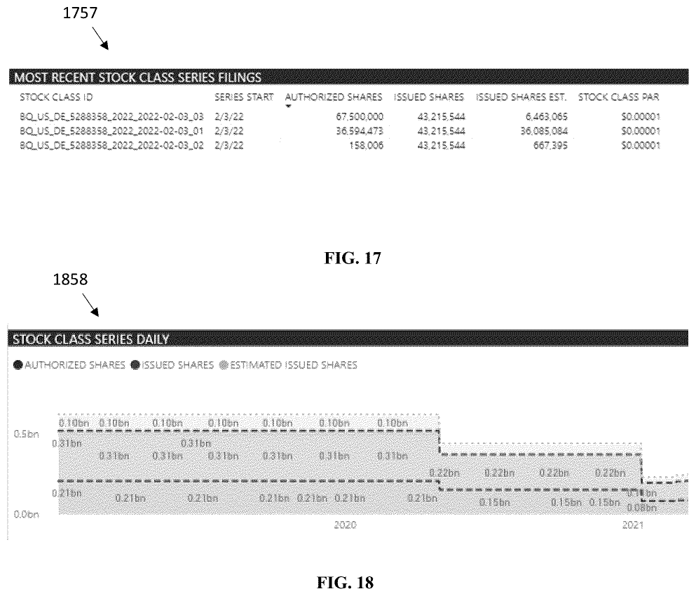

FIG. 18 illustrates a stock class series daily graph 1858 configured to permit early warning and alerts of private companies' activities, according to an aspect. Daily time series of stock filing data, normally not available, permits early warning and alerts of a private company's activities (FIG. 18). FIG. 18 shows an instant history of private company stock filings, indicating formation date, mergers and other information. This data, which is normally unavailable, shows a key history of events that reveals consistent and timely private investment data. The history of authorized, issued shares as well as total asset size shows a company's size, growth and the potential for calculating private share price may be articulated as a generated graph, as seen in FIG. 18.

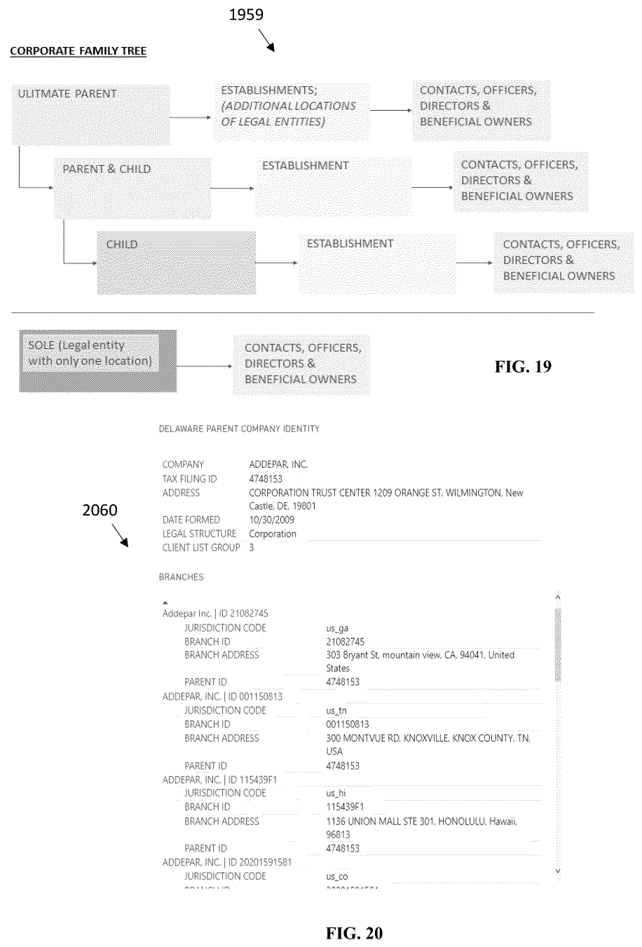

FIG. 19 illustrates a corporate family tree chart 1959, according to an aspect. FIG. 20 illustrates a Delaware parent company identity table 2060, according to an aspect. Company relationships to branches and officers are key to gaining an insight into a legal entity's standing by connecting other legal entities and individuals who run these businesses, and thus creation of a corporate family tree, as seen in FIG. 19, may be useful for articulating these relationships.

Understanding legal entity hierarchical relationships, beneficial ownership and individual officers, directors and below c-level contacts provides insights and better understanding for decision making. Business engagement with clients, vendors, investors and mergers will substantially improve compliance, underwriting, supply chain risk management, and company acquisition targets. Branch ID, address, formation data and franchise tax paid reveals verification of the branch parent as well as the branch size and if the branch is active or inactive, as articulated in FIG. 20, may also be relevant in making suitable investment decisions.

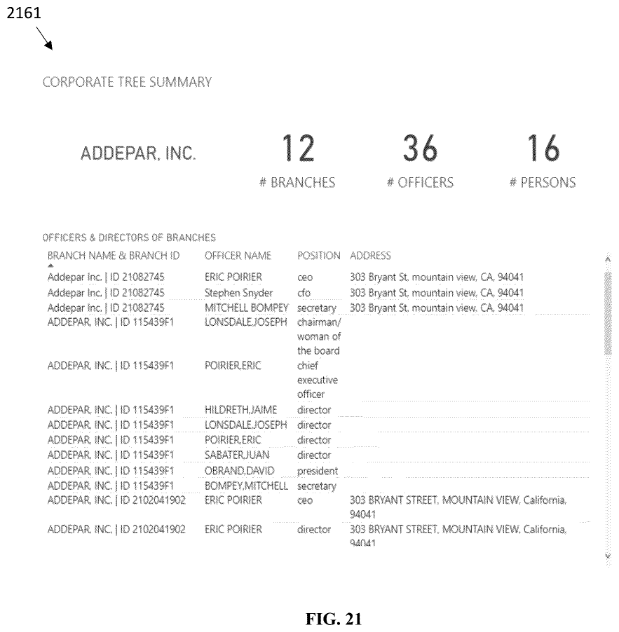

FIG. 21 illustrates a corporate tree summary graph 2161, according to an embodiment. Clearly identifying corporate officers and directors of branches in a clear format may be helpful for performing meaningful investment analysis. The ability to see branch relationships, as displayed in FIG. 21, and the officers who run these entities helps to lift the “corporate veil” of ownership. This information is key to provide parent relationships, status and permit in depth background checks of officers.

While the above described systems and method may provide a suitable approach for the monitoring of the corporate activity and the stock filings of private companies, it should be understood that future plans and developments may also be implemented in order to further improve upon the methods and systems described hereinabove. One such improvement may be pursuing analysis for companies for which the parent entity is in another State or country. Companies with parents in, for example, California, New York, or in other countries. The ability to match/connect intrastate or country legal entities permits the mapping of legal organizations regardless of location. Another potential advancement may come in the form of predictive scores. The predictive score may be generated using machine learning (ML) modeling to produce predictors of: shutdown; going IPO; raising capital; being acquired; and credit risk default.

The utilization of Peer analysis may also provide a potential avenue for advancement. Comparing public and private companies using a standardized set of metrics. Industry data or peer group data is not readily available and may be inaccurate or not reflective of the actual grouping of all companies. Existing private peer group data also is not granular by industry groupings or geographical areas. Current peer group data may provide a small sample of companies within a sector on a national basis. This does not match well to the dynamics of particular industries or local geographic areas (county), which have distinct financial margins, liquidity and other features. BQ produces highly granular industry and geographic groups for comparison of peer group data. This unique peer group data production permits highly accurate benchmarking and accurate risk assessment underwriting for daily business transactions.

In an embodiment, it may also be useful to explore the potential of forecasting of time series trends. This forecast may include: future stock authorizations of private companies; future earnings of public companies; market movements; industry trends; likelihood of expansion or contraction of a company or peer group; forecasting or predicting housing prices and forecasting or predicting the commercial lease behavior of tenants, i.e. whether a tenant renews the lease, expand the lease, etc.

Estimating the financials of private companies may also be useful to pursue as a further development. Using total assets provided by stock filing data will help derive other balance sheet items, such as equity and total liabilities. The total assets tracked over time will also lead to the development of predictive tools such as understanding when a private company requires additional funding when total assets decrease over time. Tracking total assets in a time series format will also help impute a private company's cash burn and net income losses.

Additionally, a suitable mechanism for fraud detection may be useful to further develop. The ability to identify companies that are fraudulent is currently limited to ‘already’ reported fraud events. This limitation is due to the lack of timely and available data as follows: the timely ability to understand if a legal entity is in good standing with State entities, if the company is an operating company and has recent employment filings, if the companies operating location is known, if the company has a residential or commercial address, if the companies address is active or if multiple, unrelated entities report the same address. Having the above data permits prediction of the likelihood of fraud, unlike the use of fraud data sources that state an entity has committed fraud, which is too late.

Derivative financial calculations may be pursued as well, said calculations involving combining the data with other data to create novel financial ratios and metrics.

Mechanisms for matching legal entity identifiers (LEIs) may also be useful to look into further. The legal entity identifier (LEI) is a unique global identifier for legal entities participating in financial transactions. Matching BQ data to LEIs permits the unique creation of fundamental company data (that is not available). Identification using LEIs permits international financial transactions, along with company underwriting and risk assessment. The ability to impute private stock share price permits market cap estimates, equity value and estimates of private company income statements and balance sheets may also be desirable. Additionally, changes in cash flow and burn rate can be imputed even if not currently available unless disclosed by the company itself.

Furthermore the disclosed system and method may be further adapted into commercial and real estate applications. These potential real estate applications may include standardizing credit risk ratings of commercial leases similar to debt ratings and or other long term credit obligations, determining the liquidity of illiquid real estate properties/assets. The ability to automate and standardize risk ratings of commercial leases permits the application of block chain for selling fractional cash flows and payments of contracted rents in place. With this advancement, property owners may not need to sell the whole property to convert property value to liquidity.

Further applications may be found relating to commercial lease rent insurance. The ability to standardize commercial lease risk ratings permits generation of actuarial statistics on the likelihood of rent default. Rent insurance products will be useful to insure lease capital and brokerage fees which are paid upfront, as well as rent payments over the lease term. The disclosed system may also be implemented to improve property valuations. Commercial leases are private as well as private company information. BQ's ability to provide private tenants with fundamental information permits accurate and automated credit risk of lease contracts and appropriate risk discounting of lease payments (cash flows). Discounting a property's cash flows is the standard method for appraising a property's value. Furthermore, the disclosed system may be adapted to achieve improved commercial mortgage underwriting. Commercial mortgages require a loan to value (LTV) measurement. Based upon the LTV, the maximum loan is determined. Property valuations are frequently inaccurate due to poor risk assessments of tenants, many of whom are private companies, which may be overcome through suitable implementation of the disclosed system.

This disclosure provided hereinabove presents the details of a system and method for monitoring the corporate activity and stock filings of private companies having a parent legal entity with a jurisdiction in the United States. As such, this system fills an important gap in the availability of reliable, detailed information on companies in the private sector, particularly since these firms are not bound by regulatory reporting requirements, resulting in varying levels of transparency of their operations. As disclosed herein, information, often of variable quality, may be collected from a wide range of publicly available sources. This data may then be cleansed, parsed and classified using a unique taxonomy for companies registered in the State of Delaware, after which reports are created for users in their reviews of private companies. The generated figures, tables and statistics generated by the system discussed herein may prove valuable in making decisions regarding potential investments with private companies.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternates of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. A method for monitoring and reporting the corporate activity and stock filings of private companies comprising the steps of:
obtaining relevant raw data from informational documents obtained from publicly available sources;
cleaning, parsing and classifying the raw data contained within the informational documents into intermediate data; and
using the intermediate data to create final data, wherein the final data is fed into reports prepared for users.
